(19) United States
(12) Patent Application Publication
(10) Pub. No.: US 2013/0241439 A1
(43) Pub. Date: Sep. 19, 2013

(54) Lighting Control System, Lighting Control Method, and Storage Medium

(71) Applicant: TOSHIBA LIGHTING & TECHNOLOGY CORPORATION, Yokosuka-shi (JP)

(72) Inventors: Hidenori Nishigaki, Yokosuka-shi (JP); Junko Takahashi, Yokosuka-shi (JP); Hitoshi Kawano, Yokosuka-shi (JP); Shinichi Kumashiro, Yokosuka-shi (JP)

(73) Assignee: Toshiba Lighting & Technology Corporation, Yokosuka-shi (JP)

(21) Appl. No.: 13/782,643

(22) Filed: Mar. 1, 2013

(30) Foreign Application Priority Data
Mar. 13, 2012 (JP) 2012-056258
Mar. 26, 2012 (JP) 2012-069710

(51) Int. Cl. H05B 37/02

(52) U.S. Cl. CPC H05B 37/02
USPC 315/297

(57) ABSTRACT

A lighting control system includes a plurality of lighting fixtures for ambient lighting, a plurality of lighting fixtures for task lighting, and a smart phone of a worker. The smart phone can execute an application program which controls a corresponding lighting fixture for ambient lighting, and starts up the application program when an ON state of a lighting fixture for task lighting is detected.

### CROSS-REFERENCE TO RELATED APPLICATION

This application is based upon and claims the benefit of priority from the Japanese Patent Application Nos. 2012-056258 filed on Mar. 13, 2012, and 2012-069710 filed on Mar. 26, 2012; the entire contents of all of which are incorporated herein by reference.

### FIELD

Embodiments described herein relate generally to a lighting control system, a lighting control method, and a storage medium.

### BACKGROUND

In the related art, a lighting control system which controls lighting is widely used in an office, or the like. For example, a lighting fixture is arranged in each area which is divided in an office, and lights up a corresponding area. In recent years, in order to perform power saving in an office, a Task-Ambient Lighting (TAL) system also attracts attention, and is adopted.

The Task-Ambient Lighting system is a lighting system in which only the desk surface of a worker is lighted up using a so-called task light, and lighting in the entire office is maintained to constant brightness using so-called ambient lighting. Depending on the Task-Ambient Lighting system, it is possible to realize energy saving by lighting up the entire office with modest illumination using the ambient lighting, and turning off a task light when a worker leaves his seat.

In addition, a technology is proposed in which a lighting fixture is controlled using a mobile phone which is an information terminal device. A user can light up a lighting fixture, and easily perform setting relating to lighting of the lighting fixture using a mobile phone.

However, when performing controlling of lighting using a mobile phone such as a smart phone in these days, a user should perform an operation on a screen of the smart phone by starting up an application thereof, every time the user controls a lighting fixture. Specifically, since a smart phone is a multifunctional mobile phone, many applications are mounted thereon, and are executed. For this reason, a user has to select and start up a lighting control application from many applications on a screen of the smart phone, and operate an operation button which is displayed on the application screen, and as a result, the operations become complicated.

### BRIEF DESCRIPTION OF THE DRAWINGS

FIG. 1 is a diagram which describes a lighting control system according to a first embodiment.

FIG. 2 is a schematic plan view which describes an office arrangement in which lighting fixtures according to the first embodiment are arranged.

FIG. 3 is a perspective view which describes a configuration of a smart phone according to the first embodiment.

FIG. 4 is a flowchart which illustrates an example of a flow of processing controlling an execution of an application for a lighting control in the smart phone, according to the first embodiment.

FIG. 5 is a diagram which describes a state in which a lighting fixture and a smart phone are connected through a connection cable, according to a second embodiment.

FIG. 6 is a flowchart which illustrates an example of a flow of processing controlling an execution of an application for a lighting control in the smart phone, according to the second embodiment.

FIG. 7 is a diagram which describes a lighting fixture on which a smart phone can be placed, according to a third embodiment.

FIG. 8 is a flowchart which illustrates an example of a flow of processing controlling an execution of an application for lighting control in the smart phone, according to the third embodiment.

FIG. 9 is a diagram which illustrates a configuration example of a lighting control system according to a fourth embodiment.

FIG. 10 is a diagram which illustrates an example of illumination areas according to the fourth embodiment.

FIG. 11 is a sequential diagram which illustrates an example of a lighting control in the lighting control system according to the fourth embodiment.

FIG. 12 is a diagram which illustrates an example of a layout diagram of illumination areas which are displayed on a screen of a wireless terminal according to the fourth embodiment.

FIG. 13 is a diagram which illustrates an example of an allocation table according to the fourth embodiment.

FIG. 14 is a flowchart which illustrates an example of an operation of a controller according to the fourth embodiment.

### DETAILED DESCRIPTION

A lighting control system according to the embodiments includes at least one first lighting fixture, and an information terminal device. The information terminal device includes an execution control unit which can execute an application program which controls the first lighting fixture, and executes the application program when detecting first information relating to a second lighting fixture.

### First Embodiment

### System Configuration

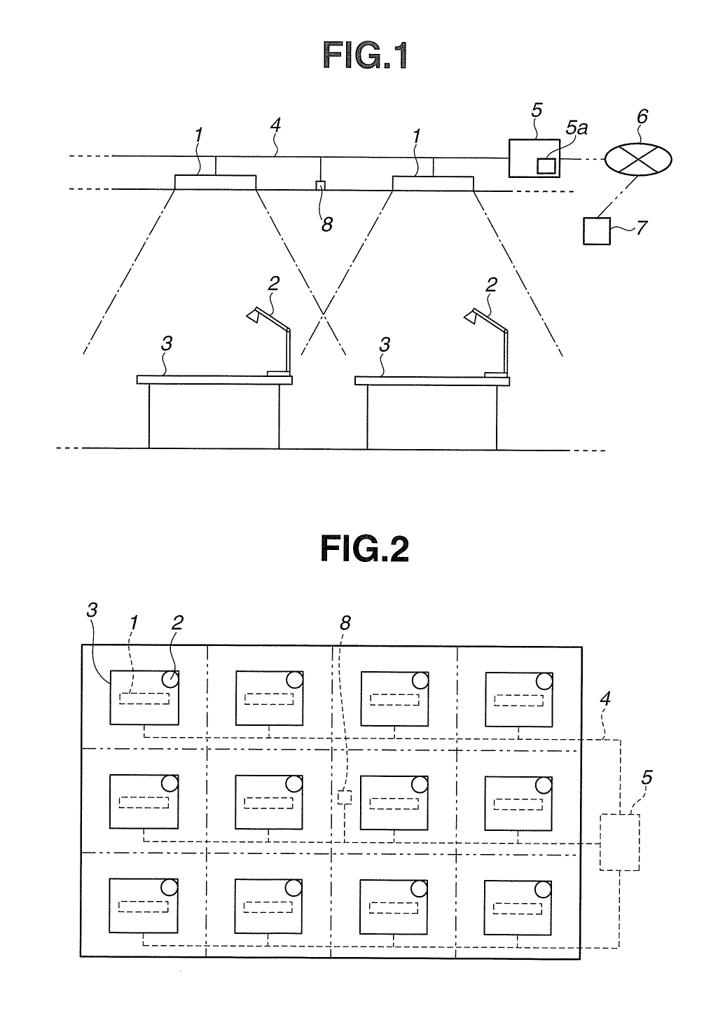

FIG. 1 is a diagram which describes a lighting control system according to the embodiment. FIG. 2 is a schematic plan view which describes an arrangement of an office in which lighting fixtures are arranged.

As illustrated in FIGS. 1 and 2, an office is divided into a plurality of areas, and a lighting fixture 1 for ambient lighting, and a lighting fixture 2 for task lighting are arranged in each area. The lighting fixture 1 for ambient lighting is attached to a ceiling plane, and the lighting fixture 2 for task lighting is provided at a desk 3 as a working table of a worker (hereinafter, referred to as user). That is, the lighting system in the office which is illustrated in FIGS. 1 and 2 is a Task-Ambient Lighting system.

In addition, here, as illustrated in FIG. 2, the office is equally divided into twelve areas, and one lighting fixture 1 for ambient lighting is installed with respect to one area, but, a method of dividing an area, and the number of lighting fixtures with respect to an area are not limited to what is illustrated in FIG. 2. For example, it may be a dividing method in which the plurality of lighting fixtures 1 are attached to one area, or one lighting fixture 1 is attached to a plurality of areas.

The plurality of lighting fixtures 1 for ambient lighting are connected to a lighting control device 5 through a communication line 4. The plurality of lighting fixtures 1 include an identifier (that is, ID, or address), respectively, and the lighting control device 5 can transmit various commands with respect to an arbitrary lighting fixture 1 by designating the identifier. A storage unit 5a of the lighting control device 5 is registered with correspondence information between an identifier of a user (that is, ID, and for example, telephone number of smart phone 11, or the like) and an area, and correspondence information between an area and the lighting fixture 1 in advance. Accordingly, the lighting control device 5 can control ON and OFF, and illuminance of the plurality of lighting fixtures 1 according to operation inputs such as ON, OFF, and adjusting of illuminance with respect to the operation panel for lighting control which is not shown.

The lighting control device 5 is also connected to the Internet 6.

In addition, an access point 7 which enables a user to wirelessly connect his smart phone to the Internet 6 is provided in the office. The access point 7 is a communication device for connecting a smart phone to the Internet 6, or a mobile phone network. Accordingly, a user is in a circumstance in which the user can freely use the Internet using a smart phone in the office.

In addition, a terminal 8 for Bluetooth (registered trademark) 8 which is one of wireless communication standards is also provided in the office. The terminal 8 is connected to the lighting control device 5 through the communication line 4. Accordingly, the terminal 8 can receive a communication signal using the Bluetooth (registered trademark), and transmit the signal to the lighting control device 5.

In addition, here, an example in which the terminal 8 is a terminal for the Bluetooth (registered trademark) is described. However, the terminal 8 may also be a device, for example, which is adaptive to other communication methods, such as a communication method based on an NFC (near field communication) of near field wireless communication, or the like.

In the above described lighting control system, it is possible to control a corresponding lighting fixture 1 using a smart phone of a user, as will be described later. Accordingly, the lighting control system is configured by the plurality of lighting fixtures 1 and a smart phone.

### Configuration of Smart Phone

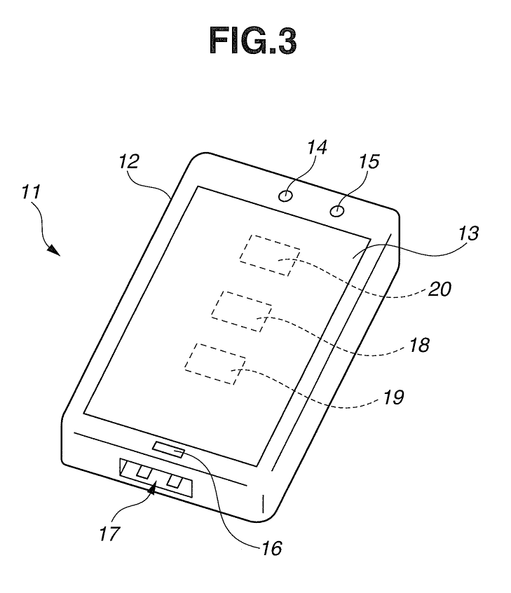

FIG. 3 is a perspective view which describes a configuration of a smart phone. A smart phone 11 includes a display unit 13 which is provided on the surface of a phone main body 12, and includes an imaging camera 14, an illuminance sensor 15, and a microphone 16 in the periphery of the display unit 13. In addition, the smart phone 11 includes a USB connector 17 as a terminal unit for being connected to various devices.

In addition, here, the smart phone which is a multifunctional mobile phone is used as an information terminal device, but, a personal computer of a tablet type or the like may be used.

The smart phone 11 is embedded with a central processing unit (hereinafter, referred to as CPU) 18, a flash memory 19 as a rewritable non-volatile memory, and a ROM and a RAM which are not shown in the main body. The CPU 18 can execute the application which is stored in the flash memory 19 and the ROM using the RAM which is a work memory.

In addition, the smart phone 11 includes a transmission and reception unit 20 for infrared communication at the rear surface, and can transmit and receive an infrared signal.

The illuminance sensor 15 is a detector which detects incident light. The illuminance sensor 15 is used in order to adjust brightness of back light in the display unit according to ambient brightness. The smart phone 11 can detect the ambient brightness of the smart phone 11, that is, illuminance of illumination light which is received by the smart phone 11 based on an output signal of the illuminance sensor 15.

In addition, the smart phone 11 has a function of connecting to the Internet 6 through the access point 7 or the like.

Accordingly, as described above, since the smart phone 11 can start up and execute various applications using the CPU 18, a user can execute a desired application by downloading the application to the flash memory 19 of the smart phone 11 using the Internet 6.

Here, a control of the lighting fixture 1 in a lighting control system 10 will be described by assuming that an application for lighting control to be described later is downloaded to the smart phone 11 in advance by a user.

### Lighting Control

A user downloads an application for lighting control, and performs the subsequent four setting in advance. The following setting is performed such that the smart phone 11 downloads the application for lighting control, starts up the application, and the application is set on a setting screen thereof.

A first setting is a setting of a threshold value TH1 for determining whether or not the lighting fixture 1 for ambient lighting will be dimmed, or turned off. The threshold value TH1 is a value which is used for being compared to illuminance which is detected by the illuminance sensor 15.

A second setting is a setting of a threshold value TH2 for determining whether or not to turn on the lighting fixture 1 which is dimmed, or turned off. The threshold value TH2 is also a value which is used for being compared to the illuminance which is detected by the illuminance sensor 15, and is lower than the threshold value TH1.

A third setting is a setting of contents of a command for controlling the lighting fixture 1. The command which is set by the third setting has different contents when the lighting fixture 1 is dimmed or turned off, and when the lighting fixture 1 is returned to the original state, that is, when the lighting fixture 1 is turned on.

Here, since the lighting control device 5 has correspondence information between information of the smart phone 11 (for example, phone number of smart phone 11, or the like) and an area, the command may be a command including information on the smart phone 11, and only an instruction on ON, OFF, or dimming.

However, for example, when the lighting control device 5 does not have the correspondence information between the information of the smart phone 11 (for example, phone number of smart phone 11, or the like) and the area, the command includes an identifier (that is, ID) of a corresponding lighting fixture 1, and an instruction on ON, OFF, or dimming.

In addition, contents of a command are different depending on a function of the smart phone 11, or the lighting fixture 1. For example, when the smart phone 11 includes an infrared light emission unit, and when the lighting fixture 1 includes an infrared light receiving unit, and can perform ON, OFF, and dimming by receiving a command for controlling through the infrared light receiving unit, contents of the command has a form of an infrared command which can be received by the lighting fixture 1, and the command is a command including an identifier (that is, ID) of the lighting fixture 1, and control contents (dimming instruction, and command of dimming amount thereof, or OFF command).

When the lighting fixture 1 does not have the infrared light receiving unit, and the lighting control device 5 stores the correspondence information between information of the smart phone 11 (for example, phone number of smart phone 11, or the like) and an area, contents of a command include information on the smart phone 11, and instruction on ON, OFF, and dimming to be transmitted to the lighting control device 5 through the Internet 6.

In addition, when the lighting control device 5 does not include information on a dimming amount corresponding to the instruction on dimming, the command also includes information on the dimming amount.

A fourth setting is a setting of a method of transmitting a command. There is a smart phone 11 having a function of infrared communication, or not, or having a function of communication using the Bluetooth (registered trademark), or not, depending on functions included therein. Accordingly, in the fourth setting, the setting is performed such that whether the command to be transmitted is transmitted from the infrared light emission unit, is transmitted to the terminal 8 using the function of the Bluetooth (registered trademark), or is transmitted to the access point 7 for the Internet 6.

As described above, the four settings are performed in advance, and the setting contents are stored in the flash memory 19 of the smart phone 11.

In addition, it is described such that, in the application, contents of processing are changed according to a comparison result between illuminance which is detected by the illuminance sensor 15 and the predetermined threshold values of TH1 and TH2. As will be described later, it is described such that, in the application, when detection illuminance is the predetermined threshold value TH1 or more, processing of dimming, or turning off the lighting fixture 1 is performed, and when the detection illuminance is the predetermined threshold value TH2 or less, processing of returning the lighting fixture 1 to the original lighting state is performed.

Actions of a user in the office are usually as follows.

When the user works at a predetermined desk 3 of his own, the smart phone 11 is placed on the desk 3. In that case, the smart phone 11 is placed on the desk 3 in order to make the display unit 13 faces a ceiling so that the illuminance sensor 15 can receive illumination light of the lighting fixture 2. As a result, the smart phone 11 is in a state of being able to detect illuminance on the desk 3 using the illuminance sensor 15.

In addition, the user turns on the lighting fixture 2 for task lighting which is attached to the desk 3 when working at the desk 3 of his own, and turns off the lighting fixture 2 when leaving the desk 3. Further, when leaving the desk 3, the user leaves the desk 3 with the smart phone 11.

When the user takes such an action, the application for lighting control which is stored in the smart phone 11 is started up in the following manner, and a control of the lighting fixture 1 is performed.

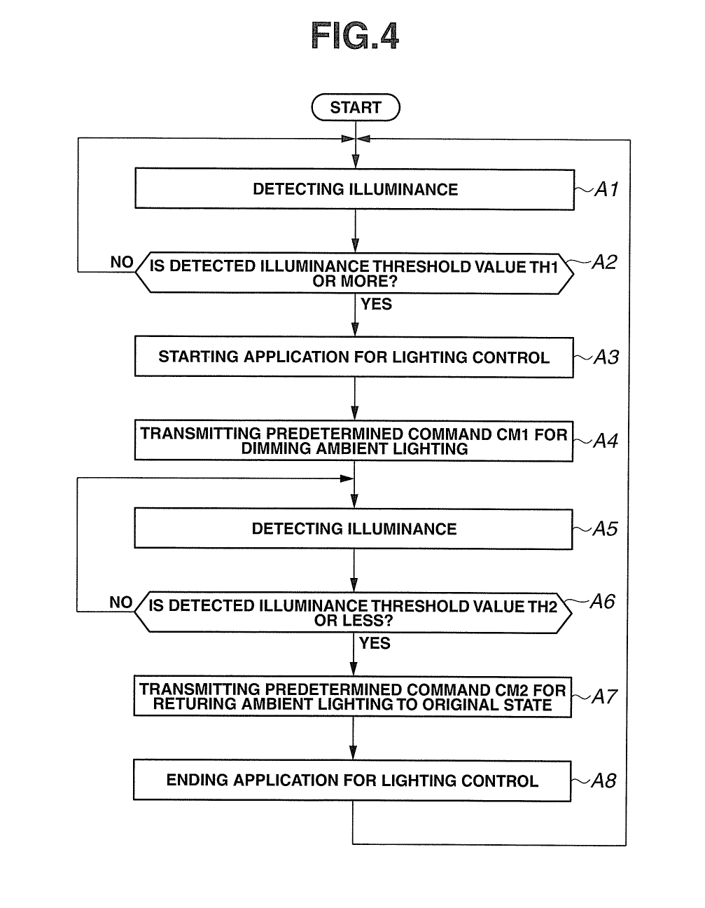

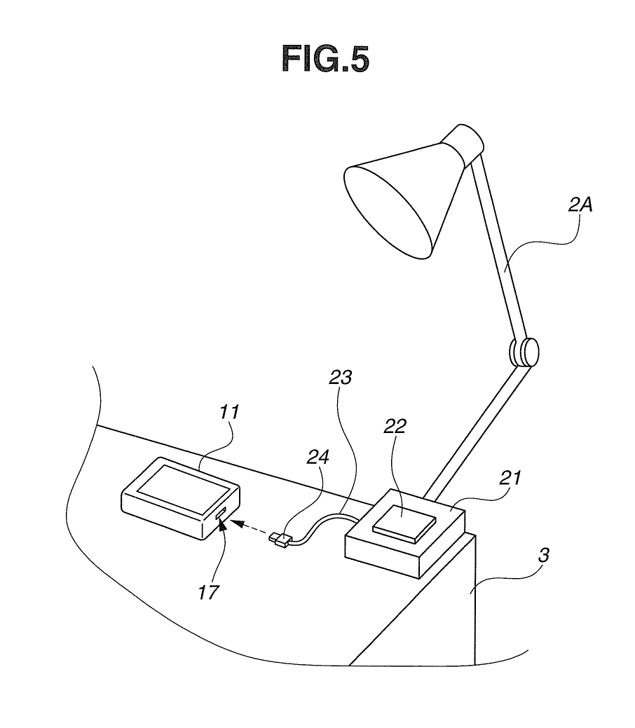

FIG. 4 is a flowchart which illustrates an example of a flow of processing controlling the execution of the application for lighting control in the smart phone 11.

When a power supply of the smart phone 11 is ON state, the CPU 18 detects illuminance based on an output signal of the illuminance sensor 15 (ACT 1).

Subsequently, the CPU 18 determines whether or not the detected illuminance is the predetermined threshold value TH1 or more (ACT 2). The threshold value TH1 which is preset by the first setting is a value by which the user can determine that the lighting fixture 2 is turned on by the illuminance sensor 15 of the smart phone 11 when the lighting fixture 2 for task lighting is turned on.

In the office, the lighting fixture 1 for ambient lighting is controlled by the lighting control device 5 so that the entire office is illuminated with modest illuminance, that is, with slightly dark illuminance. Accordingly, the predetermined threshold value TH1 is larger than an illuminance level of the ambient lighting which is detected by the illuminance sensor 15 of the smart phone 11 when the lighting fixture 1 is turned on for the ambient lighting, and is further set to a value which can detect that the lighting fixture 2 for task lighting is turned on on the desk 3.

When the detected illuminance is less than the threshold value TH1 (ACT 2:NO), processing of the CPU 18 returns to ACT 1. The processes of ACT 1 and ACT 2 are periodically performed by so-called background processing in the CPU 18.

When the detected illuminance is the threshold value TH1 or more (ACT 2:YES), the CPU 18 starts up the application for lighting control (ACT 3). The application for lighting control is stored in the flash memory 19 by being downloaded in advance. The processing in ACT 3 configures a starting control unit, or an execution control unit which starts up, or executes the application program when detecting illuminance information relating to the lighting fixture 2, that is, information denoting the ON state of the lighting fixture 2. Whether or not the lighting fixture 2 is turned on is determined based on the detected illuminance of the illuminance sensor 15, and information of a determination result when the lighting fixture 2 is turned on becomes information denoting the ON state.

The application for lighting control is started up, and is executed, but, the application executes processing of transmitting a predetermined command signal CM1 for dimming, or turning off the lighting fixture 1 for ambient lighting to the lighting control device 5 (ACT 4). That is, when the detected illuminance is the threshold value TH1 or more, a program for executing processing in which the predetermined command signal CM1 for dimming, or turning off the lighting fixture 1 for ambient lighting is transmitted to the lighting control device 5 is described in the application. The processing in ACT 4 is processing which is performed by the application. Accordingly, the processing in ACT 4 configures a command transmission unit which transmits the command signal CM1 with respect to the corresponding lighting fixture 1 by executing the started application program.

The transmitted command signal CM1 at this time has contents which are set in advance by the above described third setting, and transmitting of the command signal CM1 is performed by a method or a unit which is set through the above described fourth setting.

In addition, at the time of executing processes of ACT 3 and ACT 4, a screen for confirming, or a screen for instructing transmitting the command signal CM1 to the lighting fixture 1 may be displayed on the display unit 13 of the smart phone 11. In that case, processes of ACT 3 and ACT 4 are executed by receiving an instruction of a user with respect to such displayed screens.

When receiving the command signal CM1, the lighting control device 5 controls the corresponding lighting fixture 1 to be dimmed, or turned off. That is, the smart phone 11 configures an information terminal device including a starting control unit, or an execution control unit which can execute the application program which controls the lighting fixture 1, and starts or executes the application program when detecting information relating to the lighting fixture 2 (here, information denoting that the lighting fixture 2 is turned on due to illuminance), and a command transmission unit which transmits the command signal CM1 with respect to the lighting fixture 1 by executing the started application program.

As described above, when the user starts a work in his area, the lighting fixture 1 for ambient lighting is dimmed, or turned off by the application for lighting control of the smart phone 11. Accordingly, the user can make the lighting fixture 1 for ambient lighting be dimmed, or be turned off only by placing the smart phone 11 on the desk 3 without starting up the application.

In addition, in the above described example, detecting of illuminance, and determining processing are performed using a separate program from the application program, but, the detecting of illuminance, and the determining processing may be performed using the application program.

For example, the user starts up the application program, and the CPU 18 executes the application program using so-called background processing, and performs the detecting of illuminance, and the determining processing. In addition, a determination on whether or not the detected illuminance is the threshold value TH1 or more is performed using the so-called background processing, and when the detected illuminance is determined to be the threshold value TH1 or more, the processes in ACT 3 and ACT 4 in the application program are executed.

That is, the processes from ACT 1 to ACT 4 may be executed using the application program.

Thereafter, the CPU 18 performs detecting of illuminance based on an output signal of the illuminance sensor 15 after starting and executing the application program (ACT 5).

When the user leaves his desk 3, the user turns off the lighting fixture 2 for task lighting, or leaves the desk 3 with the smart phone 11.

As a result, the detected illuminance level of the illuminance sensor 15 is decreased since the illuminance sensor 15 cannot receive illumination light from the lighting fixture 2, or since the smart phone 11 is put in a pocket, or the like, of the user when being carried.

The CPU 18 periodically detects the illuminance from the output signal of the illuminance sensor 15, and determines whether or not the detected illuminance is the predetermined threshold value TH2 or less (ACT 6). The threshold value TH2 which is preset by the above described second setting is preset to a value which can determine whether the lighting fixture 2 is turned off, or the smart phone 11 is carried by the user by the illuminance sensor 15 of the smart phone 11, in order to turn on the lighting fixture 1 which is dimmed, or turned off.

Accordingly, when the detected illuminance exceeds the threshold value TH2 (ACT 6:NO), processing of the CPU 18 returns to ACT 5. In the CPU 18, the processes of ACT 5 and ACT 6 are also periodically performed using the so-call background processing.

When the detected illuminance is the predetermined threshold value TH2 or less (ACT 6:YES), since the detected illuminance is the predetermined threshold value TH2 or less, the application executes processing of transmitting a predetermined command signal CM2 for turning on the lighting fixture 1 for ambient lighting to the lighting control device 5 (ACT 7). That is, the application is described with a program which executes the processing of transmitting the predetermined command signal CM2 for turning on the lighting fixture 1 for ambient lighting to the lighting control device 5, when the detected illuminance is the threshold value TH2 or less. The processing in ACT 7 is processing which is performed by the application. Accordingly, the processing in ACT 7 configures a command transmission unit which transmits the command signal CM2 with respect to the corresponding lighting fixture 1 by executing the started application program when illuminance information relating to the lighting fixture 2, that is, information denoting that the lighting fixture 2 is turned off is detected.

The transmitted command signal at this time has contents which are set in advance by the above described third setting, and transmitting of the command signal is performed by a method, or a unit which is set through the above described fourth setting.

When receiving the command signal CM2, the lighting control device 5 controls the corresponding lighting fixture 1 so as to make the original lighting state, that is, the illuminance level for the ambient lighting.

In addition, the lighting control device 5 may perform a lighting control corresponding to the above described ACT 4 and ACT 7 by temporarily stopping a control of making the lighting fixture 1 be the ambient lighting state when receiving the command signal CM1, and by releasing the temporary stopping when receiving the command signal CM2.

Further, the processes of ACT 4 and ACT 7 may be instructed by the user using a manual. For example, the processes may be performed such that a button display of turning off the lighting fixture 1 is displayed on the display unit 13 when the application is started, and the command signal CM1 is transmitted when the user operates the button. In addition, the processes may be performed such that the command signal CM2 is transmitted when the button display of turning on the lighting fixture 1 (that is, returning to original state) is displayed on the display unit 13, and the user operates the button, even when the detected illuminance is the threshold value TH2 or less after dimming, or turning off the lighting fixture 1, temporarily.

After ACT 7, the CPU 18 ends the application (ACT 8), and processing returns to ACT 1. The processing in ACT 8 configures an ending control unit which ends the application program after transmitting the command signal CM2.

Accordingly, the smart phone 11 configures an information terminal device which includes a command transmission unit which transmits the command signal CM2 with respect to the corresponding lighting fixture 1 by executing the started application program when second information relating to the lighting fixture 2 (here, information denoting that the lighting fixture 2 is turned off due to illuminance) is detected, and the ending control unit which ends the application program after transmitting the command signal CM2.

Accordingly, when the user places the smart phone 11 on the desk 3, and turns on the lighting fixture 2 for task lighting, the corresponding lighting fixture 1 for ambient lighting is automatically dimmed, or turned off without a complicated operation by a user with respect to the smart phone 11.

Further, when the user turns off the lighting fixture 2, or leaves the desk 3 with the smart phone 11 in such a state, the lighting fixture 1 for ambient lighting in the corresponding area automatically returns to the original ambient lighting state without a complicated operation by the user with respect to the smart phone 11.

As described above, according to the embodiment, it is possible to realize a lighting control system which can control a lighting fixture without a complicated operation with respect to the information terminal device.

### Second Embodiment

In the above described embodiment, the application for lighting control is started, and ended based on the illuminance of the illuminance sensor 15 which is provided in the smart phone 11, but, according to the embodiment, an execution, or starting of the application for lighting control is controlled based on a connection state between the smart phone 11 and a lighting fixture 2A for task lighting.

Since configurations of a lighting control system according to the embodiment are approximately the same as those in the lighting control system according to the first embodiment, configurations which are different from those in the lighting control system according to the first embodiment will be described, and the same constituent elements are given the same reference numerals, and descriptions thereof will be omitted.

FIG. 5 is a diagram which describes a state in which the lighting fixture 2A according to the embodiment and the smart phone 11 are connected using a connection cable. As illustrated in FIG. 5, a pedestal 21 of the lighting fixture 2A for task lighting which is provided on the desk 3 is provided with a switch 22 for ON/OFF. When the user pushes the switch 22, the lighting fixture 2A is switched from ON to OFF, or from OFF to ON.

Further, the lighting fixture 2A includes a processing circuit therein, and a cable 23 is extended from the lighting fixture 2A. A connector for connecting, here, a USB connector 24 is provided at a tip end portion of the cable 23. The USB connector 24 is a male mold, and as denoted in dotted lines, can be connected to a USB connector 17 of a female mold of the smart phone 11. The lighting fixture 2A can output a predetermined signal from the processing circuit therein through the USB connector 24.

When the user pushes the switch 22 of the lighting fixture 2A, and the USB connector 24 is connected to the USB connector 17 of the smart phone 11 in an ON state of the lighting fixture 2A, the CPU 18 of the smart phone 11 starts the application for lighting control.

In addition, when the user disconnects the USB connector 24 from the USB connector 17 of the smart phone 11, the CPU 18 of the smart phone 11 ends the application for lighting control.

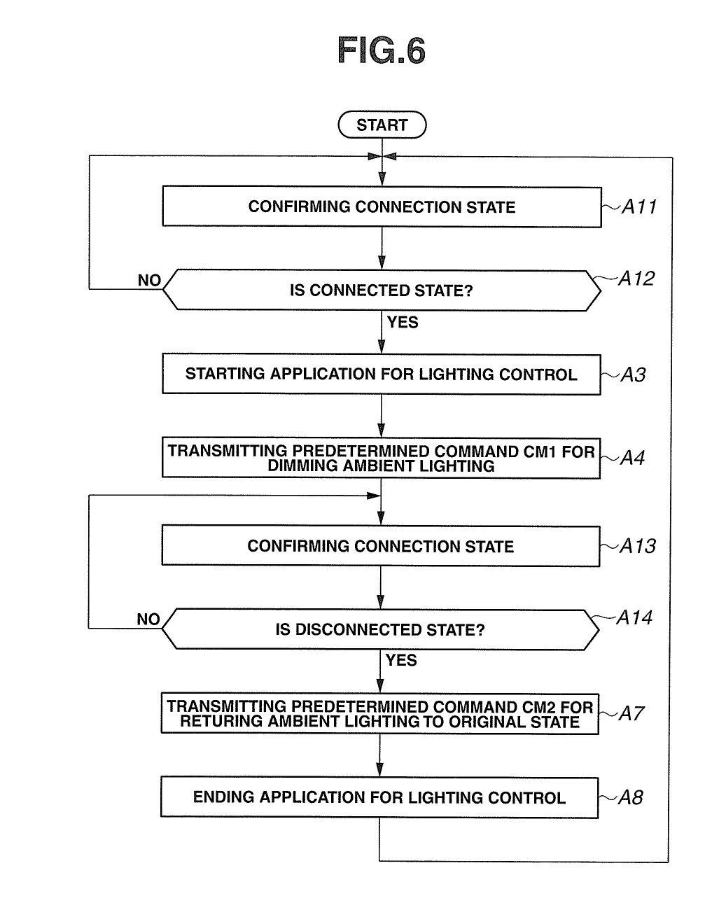

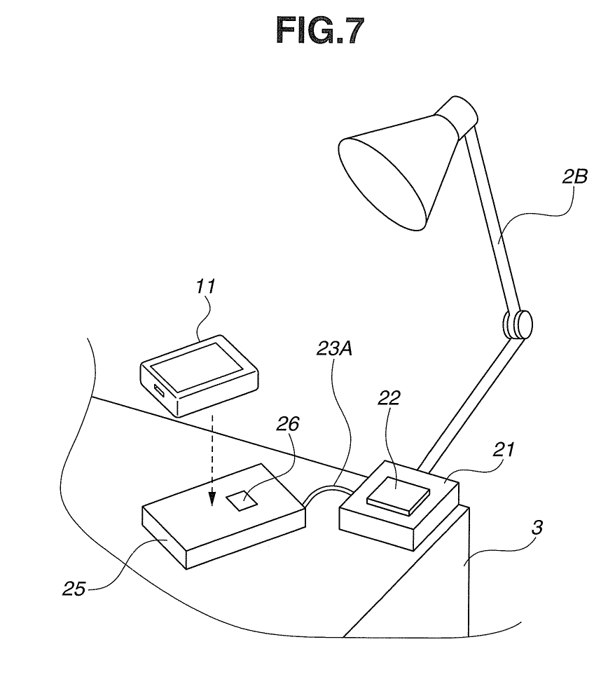

FIG. 6 is a flowchart which illustrates a flow of processing of controlling the execution of the application for lighting control in the smart phone 11 according to the embodiment. In FIG. 6, the same processes as those in FIG. 4 are given the same action numbers, and descriptions thereof will be omitted.

When the power supply of the smart phone 11 in ON state, the CPU 18 confirms the connection state between the smart phone 11 and the lighting fixture 2A (ACT 11). The confirmation is performed by determining whether or not the USB connector 24 is connected to the USB connector 17. The confirmation of the connection state is performed, for example, depending on whether or not the CPU 18 can communicate with the processing circuit of the lighting fixture 2A, using a communication with the processing circuit of the lighting fixture 2A through the USB connector 17.

The CPU 18 determines whether or not the smart phone 11 is connected to the lighting fixture 2A based on the confirmation of the connection state in ACT 11 (ACT 12). When the smart phone 11 is connected to the lighting fixture 2A (ACT 12:YES), the CPU 18 starts the application for lighting control (ACT 3). The processing in ACT 3 configures a start control unit which starts the application program when detecting the connection state between the smart phone 11 and the lighting fixture 2, as information denoting the ON state of the lighting fixture 2.

When the smart phone 11 is not connected to the lighting fixture 2A (ACT 12:NO), processing of the CPU 18 returns to ACT 11.

In addition, in the above described example, the processing of determining the connection state between the smart phone 11 and the lighting fixture 2A is performed by a separate program from the application program, but, the determining processing may be performed using the application program.

For example, after the user starts the application program, the CPU 18 performs the determining processing of the connection state by executing the application program using the so-called background processing. In addition, when the connection determination between the smart phone 11 and the lighting fixture 2A is performed using the so-called background processing, and the connection is confirmed, processes in ACT 3 and ACT 4 in the application program are executed.

That is, processes from ACT 11 to ACT 4 may be executed using the application program.

After transmitting the predetermined command signal CM1, the CPU 18 confirms the connection state between the smart phone 11 and the lighting fixture 2A (ACT 13). The confirmation is also performed by determining whether or not the USB connector 24 is connected to the USB connector 17, similarly to ACT 11. The CPU 18 determines whether or not the smart phone 11 is detached from the lighting fixture 2A based on the confirmation of the connection state in ACT 13 (ACT 14).

When the smart phone 11 is not detached from the lighting fixture 2A (ACT 14:NO), processing returns to the processing in ACT 13. When the smart phone 11 is detached from the lighting fixture 2A (ACT 14:YES), processing proceeds to processing in ACT 7. The processing in ACT 7 configures a command transmission unit which transmits the command signal CM2 with respect to the corresponding lighting fixture 1 by executing the started application program, when detecting information on connection state between the smart phone 11 and the lighting fixture 2, that is, the information denoting the OFF state of the lighting fixture 2

In the CPU 18, the above described processes in ACT 11, ACT 12, ACT 13, and ACT 14 are also periodically performed using the so-called background processing.

Other processes are the same as those in the first embodiment.

Accordingly, the lighting fixture 1 for ambient lighting in the corresponding area is automatically dimmed, or turned off when the user only connects the smart phone 11 to the cable 23 of the lighting fixture 2 without performing a complicated operation with respect to the smart phone 11.

Further, the lighting fixture 1 for ambient lighting in the corresponding area automatically returns to the original ambient lighting state, when the user detaches the cable 23 of the lighting fixture 2 from the smart phone 11 in such a state, without performing a complicated operation with respect to the smart phone 11.

As described above, according to the embodiment, it is possible to realize a lighting control system which can control a lighting fixture without performing a complicated operation with respect to the information terminal device.

In addition, in the above described example, the connection between the smart phone 11 and the lighting fixture 2A is determined by determining whether or not the smart phone receives a predetermined signal by performing a predetermined communication between the smart phone 11 and the lighting fixture 2A, but, the connection, simply, whether or not the smart phone and the lighting fixture are connected may be detected, for example, by detecting a conduction state between terminals, without performing the communication.

Further, in the above described example, the connection between the smart phone 11 and the lighting fixture 2A is determined by determining whether or not the connection cable 23 is connected, but, the determination may be performed by determining whether or not the communication with the lighting fixture 2A using a wireless communication can be established.

### Third Embodiment

According to the second embodiment, the application for lighting control is started and ended based on the connection state between the smart phone 11 and the lighting fixture 2A for task lighting, but, according to the embodiment, the application for lighting control is executed, or started, and ended based on a reception of a predetermined signal by the smart phone 11.

Since configurations of a lighting control system according to the embodiment are approximately the same as those in the lighting control system according to the first and second embodiments, different configurations from the constituent elements of the lighting control systems in the first and second embodiments are described, the same constituent elements are given the same reference numerals, and descriptions thereof will be omitted.

FIG. 7 is a diagram which describes a lighting fixture 2B according to the embodiment on which the smart phone 11 can be mounted.

As illustrated in FIG. 7, a pedestal 21 of the lighting fixture 2B for task lighting which is provided on a desk 3 is provided with an ON/OFF switch 22. When a user pushes the switch 22, the lighting fixture 2B is switched from OFF to ON, or from ON to OFF.

In addition, the lighting fixture 2B is connected with a mounting table 25 through a connection cable 23A. The mounting table 25 includes a transmission and reception unit 26 for an infrared communication on the upper surface. The smart phone 11 can be mounted on the mounting table 25, and a transmission and reception unit 20 for infrared communication of the smart phone 11 can receive an infrared signal from the transmission and reception unit 26 of the mounting table 25 when the smart phone 11 is mounted on the mounting table 25.

Further, the lighting fixture 2B includes a processing circuit therein, and the processing circuit operates so that a predetermined infrared signal, for example, an ON signal is output from the transmission and reception unit 26 of the mounting table 25 when the switch 22 is pushed, and turned on. In addition, the processing circuit operates so that a predetermined infrared signal, for example, an OFF signal is output from the transmission and reception unit 26 of the mounting table 25 when the switch 22 is pushed, and turned off.

When the user pushes the switch 22 of the lighting fixture 2B in a state of placing the smart phone 11 on the mounting table 25, and turns on the lighting fixture 2B, the transmission and reception unit 20 of infrared light of the smart phone 11 receives a predetermined signal (ON signal) from the transmission and reception unit 26 of infrared light of the mounting table 25, and the CPU 18 of the smart phone 11 starts the application for lighting control.

In addition, when the user pushes the switch 22 of the lighting fixture 2B in a state of placing the smart phone 11 on the mounting table 25, and turns off the lighting fixture 2B, the transmission and reception unit 20 of infrared light of the smart phone 11 receives a predetermined signal (OFF signal) from the transmission and reception unit 26 of infrared light of the mounting table 25, and the CPU 18 of the smart phone 11 ends the application for lighting control.

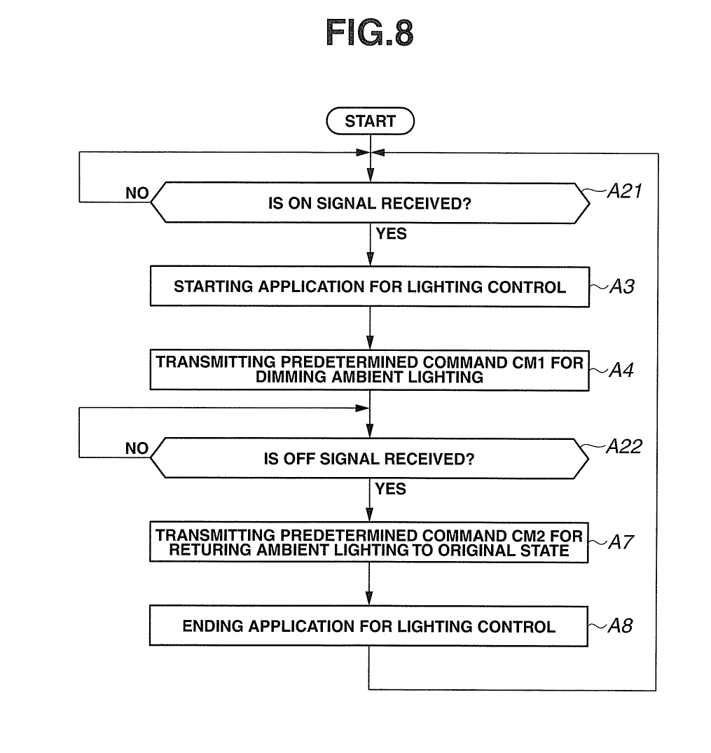

FIG. 8 is a flowchart which illustrates a flow of processing controlling an execution of the application for lighting control in the smart phone 11 according to the embodiment. In FIG. 8, the same processes as those in FIG. 4 are given the same reference numerals, and description thereof will be omitted.

When the power supply of the smart phone 11 is ON state, the CPU 18 determines whether or not the transmission and reception unit 20 receives the ON signal (ACT 21).

When the transmission and reception unit 20 receives the ON signal (ACT 21:YES), the CPU 18 starts the application for lighting control (ACT 3). The processing in ACT 3 configures a start control unit which starts the application program when information on a predetermined signal (ON signal) is detected from the lighting fixture 2 as information denoting the ON state of the lighting fixture 2.

When the transmission and reception unit 20 does not receive the ON signal (ACT 21:NO), there is no processing in the CPU 18.

In addition, in the above described example, the processing of determining on whether or not the predetermined signal is received is performed by a separate program from the application program, but, the processing may be performed using the application program.

For example, the CPU 18 performs the processing of determining on whether or not the predetermined signal is received by executing the application program using the so-called background processing, after the user starts the application program. In addition, when determination on connection between the smart phone 11 and the lighting fixture 2A is performed using the so-called background, and the reception of the predetermined signal is confirmed, the processes in ACT 3 and ACT 4 in the application program are executed.

That is, the processes from ACT 21 to ACT 4 may be executed using the application program.

After transmitting the predetermined command signal CM1, the CPU 18 determines whether or not the transmission and reception unit 20 receives the OFF signal (ACT 22).

When the transmission and reception unit 20 does not receive the OFF signal (ACT 22:NO), there is no processing to be performed. When the transmission and reception unit 20 receives the OFF signal (ACT 22:YES), processing proceeds to ACT 7. The processing in ACT 7 configures a command transmission unit which transmits the command signal CM2 with respect to the corresponding lighting fixture 1 by executing the started application program, when detecting information on the predetermined signal (OFF signal) from the lighting fixture 2, that is, information denoting the OFF state of the lighting fixture 2.

The above described processes in ACT 21 and ACT 22 are periodically performed by the so-called background processing in the CPU 18.

Other processes are the same as those in the first embodiment.

Accordingly, the lighting fixture 1 for ambient lighting in the corresponding area is automatically dimmed, or turned off when the user only performs an ON operation of the lighting fixture 2B by placing the smart phone 11 on the mounting table 25 without performing a complicated operation with respect to the smart phone 11.

Further, the lighting fixture 1 for ambient lighting in the corresponding area automatically returns to the original state of ambient lighting when the user performs the OFF operation of the lighting fixture 2B in such a state, without performing a complicated operation with respect to the smart phone 11.

As described above, according to the embodiment, it is possible to realize a lighting control system which can control a lighting fixture without performing a complicated operation with respect to the information terminal device.

In addition, in the above described example, the communication between the smart phone 11 and the lighting fixture 2A is the infrared communication, but, the communication may be other communications than that.

As described above, according to the above described lighting control system in the first, second, and third embodiments, it is possible to realize a lighting control system, and a lighting control method which can control a lighting fixture without performing a complicated operation with respect to the information terminal device.

### Fourth Embodiment

The lighting control system according to the first to third embodiments can operate the lighting fixture without performing a complicated operation with respect to the information terminal device, but, in an lighting control system according to the embodiment, a control unit transmits area information of an illumination area to the information terminal device according to an acquisition request of the area information from the information terminal device, the information terminal device creates a layout chart of the illumination area based on the area information, and displays the chart on a screen of a display, and the control unit can control a group of a predetermined lighting fixtures among a plurality of lighting fixtures by transmitting area instruction information using the layout chart.

In a lighting control system in the related art, generally, a plurality of lighting fixtures which are provided in an office, or the like, are divided into a predetermined area unit, and are made into a group, respectively, and the ON/OFF of the lighting fixture is controlled in the unit of group. At this time, a switch is provided in the unit of group, and a user in an office, or the like performs ON/OFF of lighting in the unit of group by operating the switch which is provided on the wall surface, or the like.

In this manner, in the lighting control system in the related art, every person who can operate a switch can perform the ON/OFF of lighting.

On the other hand, there is a need not to perform ON/OFF by other persons in an area in which users are limited, in an area in which works are continuously performed for a long time, or the like, that is, lighting in the area is to be exclusively performed.

However, in many cases, it is not assumed that, an illumination area in which the lighting control system in the related art is used, for example, in an illumination area in which a plurality of users share the area such as an office, or the like, a specified individual can exclusively control ON/OFF of lighting. That is, since it is possible for anyone else who operates a switch to control ON/OFF of lighting, there is a possibility that the lighting being in use may be turned off by another person.

In the lighting control system according to the embodiment, an illumination area is divided into a plurality of division areas which are not overlapped, and a control of a lighting fixture is performed in each division area. In addition, the lighting control system according to the embodiment includes a plurality of groups of lighting fixtures as a group of the lighting fixture in each division area. The terminal device performs a control of a predetermined group of lighting fixtures when an area instruction information denoting that the predetermined group of lighting fixtures among the plurality of groups of lighting fixtures is desired to be controlled is transmitted, and the control of the predetermined group of lighting fixtures if permitted as a response thereof. In addition, when determining whether or not the division areas including the predetermined group of lighting fixtures which are denoted by the area instruction information are allocated is performed, and when the division areas are not allocated, the control unit makes a switch control with respect to the predetermined group of lighting fixtures in the division area invalid, and permits a control with respect to the predetermined group of lighting fixtures from the terminal device.

According to the embodiment which will be described below, it is possible to provide a lighting control system in which the lighting of a predetermined area in an illumination area which is shared by a plurality of users can be switched to lighting which can be exclusively controlled by a specified individual.

Specifically, according to the embodiment which will be described below, a lighting control system is divided into a plurality of areas 1, 2, 3, 4, . . . in which illumination areas are not overlapped, and a lighting fixture 33 is controlled in each area. In addition, the lighting control system includes a plurality of groups of lighting fixtures as the group of the lighting fixture 33 in each division area. For example, when area instruction information denoting that the lighting fixture 33 in the area 1 among the plurality of groups of the lighting fixtures is desired to be controlled is transmitted, and a control with respect to the lighting fixture 33 in the area 1 is permitted as a response thereof, a wireless terminal 35-1 in the lighting control system performs the control of the lighting fixture 33 in the area 1. In addition, a controller 31 in the lighting control system determines whether or not the area 1 which is denoted by the area instruction information is allocated, and when the area 1 is not allocated, make a switch control with respect to the lighting fixture 33 in the area 1 invalid, and permits the control of the lighting fixture 33 in the area 1 from the wireless terminal 35-1.

In addition, according to the embodiment, the controller 31 makes a reply of the area information of the illumination area when receiving an acquisition request of the area information of the illumination area from the wireless terminal 35-1. In addition, the wireless terminal 35-1 creates a layout chart of the illumination area based on the received area information, and displays the chart, and for example, creates area instruction information based on the area 1 which is instructed using the layout chart.

In addition, according to the embodiment, when receiving area instruction information denoting that the lighting fixture 33 in the area 1 is desired to be controlled from the wireless terminals of 35-1, 35-2, 35-3, . . . , the controller 31 permits the control with respect to the lighting fixture 33 in the area 1 to the wireless terminal which first transmits the received area instruction information.

In addition, according to the embodiment, the controller 31 stores the order of priority of each wireless terminal in advance, and for example, when receiving the area instruction information denoting that the lighting fixture 33 in the area 1 is desired to be controlled from the wireless terminals of 35-1 and 35-2, or when receiving area instruction information denoting that the lighting fixture 33 in the area 1 is further desired to be controlled from the wireless terminal 35-1 in a state in which the control with respect to the lighting fixture 33 in the area 1 is permitted to the wireless terminals of 35-2 in advance, the control of the lighting fixture 33 in the area 1 is permitted to a wireless terminal with the highest order of priority.

In addition, according to the embodiment, for example, when cancelling the state in which the lighting fixture 33 in the area 1 can be controlled, the wireless terminal 35-1 transmits a cancellation notice to the controller 31. In addition, the controller 31 which receives the cancellation notice performs processing of not allowing the control of the lighting fixture 33 in the area 1 from the wireless terminal 35-1, and makes a switch control with respect to the lighting fixture 33 in the area 1 valid, thereafter.

### Configuration Example of Lighting Control System

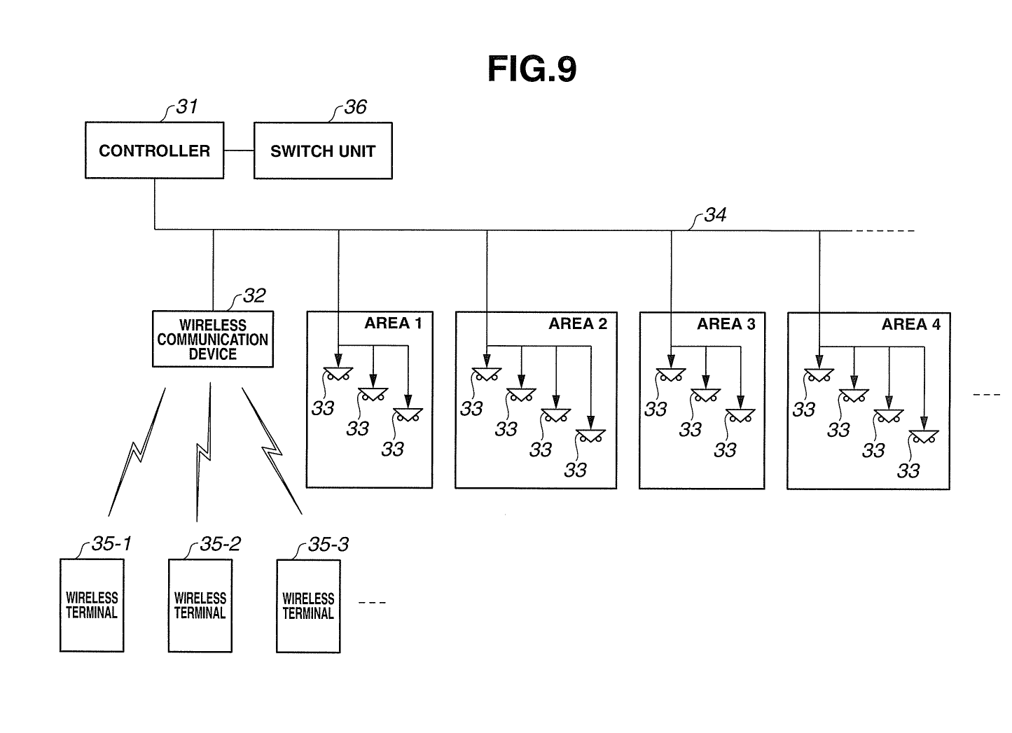

FIG. 9 is a diagram which illustrates a configuration example of the lighting control system according to the embodiment. In FIG. 9, in the lighting control system, the controller 31, a wireless communication device 32, and the plurality of lighting fixtures 33 are connected by a transmission line 34, respectively. In addition, the controller 31 and the wireless terminals 35-1, 35-2, 35-3, . . . (hereinafter, there is a case of referring to these wireless terminals, simply as wireless terminal 35) can perform a communication through the wireless communication device 32.

In FIG. 9, the controller 31 has a function of controlling the lighting fixture 33 in the lighting control system. In addition, the wireless communication device 32 relays a communication between the controller 31 and the wireless terminal 35. In addition, the wireless communication device 32 does not necessarily have to be a device which exclusively performs a communication, and for example, the device may have a configuration of being included in the lighting fixture 33. In addition, it is not necessary to provide one wireless communication device 32 in the lighting control system, and a plurality of devices may be provided according to an extent of the illumination area.

In addition, the wireless terminal 35 according to the embodiment is a smart phone, a multifunction mobile terminal of a tablet type, a PDA (personal digital assistant) terminal, a personal computer, or the like, and is connected to the wireless communication device 32 using a technology of near field wireless communication (Bluetooth (registered trademark)), a UWB (ultra wide band), a ZigBee (registered trademark), an NFC (near field communication), or the like.

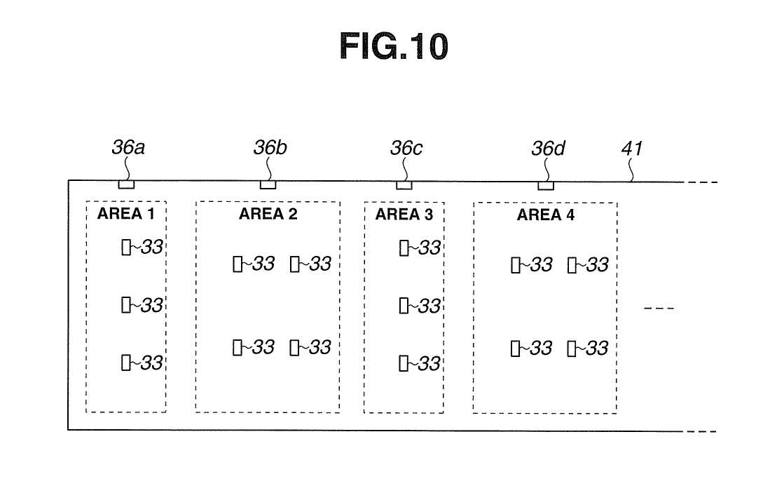

In addition, in FIG. 9, in the lighting control system according to the embodiment, an illumination area in an office or the like is divided into area 1, area 2, area 3, area 4, . . . , without being overlapped, and the lighting fixtures 33 which are included in each area are set as a group in each area. In addition, when a user of lighting who is registered at an office or the like operates a switch unit 36 which is provided in each area (unit of group), it is possible to control the lighting fixtures 33 in each area. FIG. 10 is a diagram which illustrates an example of an illumination area, and denotes an illumination area 41 in an office or the like. Here, it is possible to control the lighting fixtures 33 in each area, as an example, by providing switches 36a, 36b, 36c, 36d, . . . , respectively in a unit of an area 1, area 2, area 3, area 4, . . . , and operating the switches 36a, 36b, 36c, 36d, . . . .

### Operation of Lighting Control System

Subsequently, characteristic operations of the lighting control system according to the embodiment will be described. In addition, according to the embodiment, it is assumed that the wireless terminals 35-1. 35-2, 35-3, . . . are installed with software of the application for lighting control, respectively. In addition, area information of the illumination area 41 shown in FIG. 10, that is, area position information denoting each area range in the illumination area 41, and lighting position information denoting a position of the lighting fixtures 33 which are arranged in each area are assumed to be managed by the controller 31.

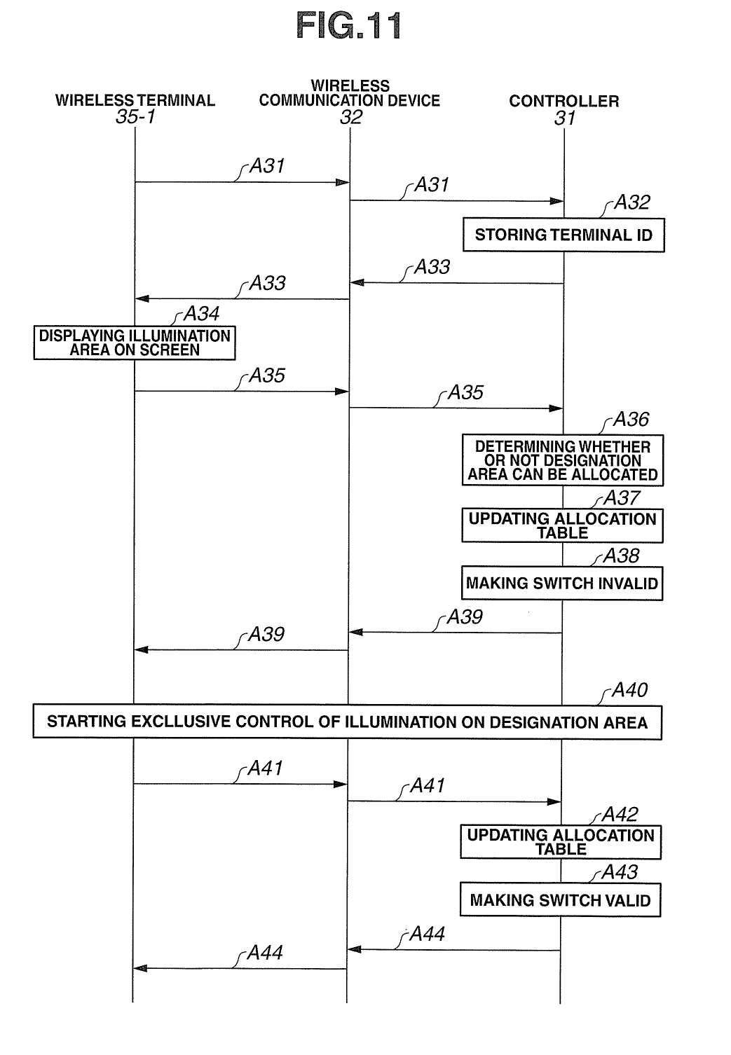

FIG. 11 is a sequence diagram which illustrates an example of a lighting control in the lighting control system according to the embodiment. According to the embodiment, as an example, a case will be described in which setting of the controller 31 is performed so that the ON/OFF control of the lighting fixtures 33 in the area 1 is exclusively performed from the wireless terminal 35-1, using the wireless terminal 35-1 which is installed with the above described application software. In addition, the following processing can be executed in all of the wireless terminals to which the above described application software is installed.

First, the wireless terminal 35-1 transmits an acquisition request of the area information of the illumination area 41 (including terminal ID of own device (specific ID of wireless terminal such as phone number, device ID, MAC address, IP address) to the controller 31 according to an operation by a user of the own device (ACT 31).

The controller 31 which receives the acquisition request of the area information through the wireless communication device 32 extracts a terminal ID from the received acquisition request, and stores the ID (ACT 32). In addition, the controller 31 transmits the area information of the illumination area 41 to the wireless terminal 35-1 (ACT 33).

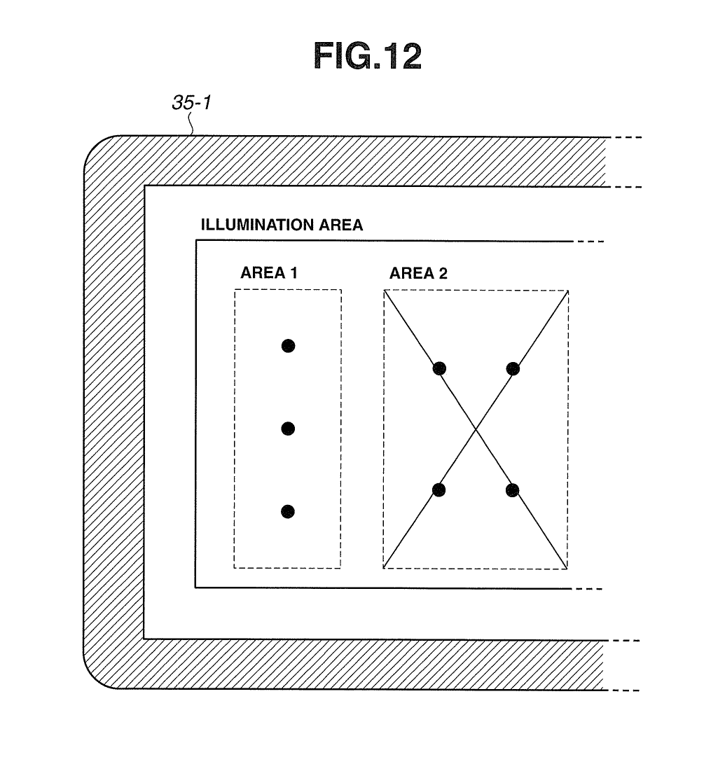

The wireless terminal 35-1 which receives the area information through the wireless communication device 32 creates a layout chart of the illumination area based on the area position information and the lighting position information included in the area information, and for example, displays a display screen which is illustrated in FIG. 12 (ACT 34). FIG. 12 is a diagram which illustrates an example of the layout chart of the illumination area which is displayed on a screen of the wireless terminal 35-1. Here, portions which are surrounded with dotted lines denote an area 1, an area 2, . . . , and black dots denote positions of the lighting fixtures 33. In addition, a state in which the area 2 is already allocated to another wireless terminal is denoted.

In addition, when the user of the wireless terminal 35-1 touches the portion which is surrounded by the dotted line in the area 1, the wireless terminal 35-1 generates area instruction information (including terminal ID) denoting that the lighting fixtures 33 in the area 1 are desired to be exclusively controlled, and transmits the information to the controller 31 (ACT 35). In addition, according to the embodiment, it is assumed that, even when the area 2 (portion which is surrounded with dotted line) which is already allocated to another wireless terminal is touched, there is no processing to be performed.

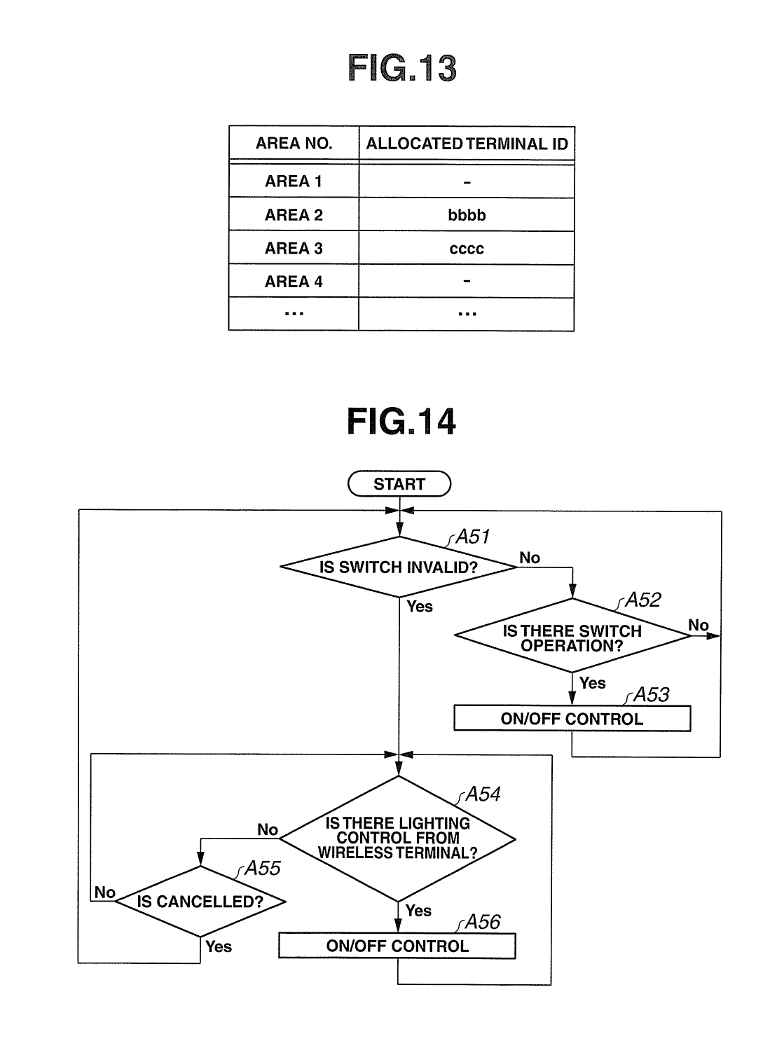

The controller 31 which receives the area instruction information through the wireless communication device 32 determines whether or not the area 1 which is denoted by the area instruction information is allocated to another user by confirming an allocation table which is illustrated in FIG. 13 (ACT 36). FIG. 13 is a diagram which illustrates an example of the allocation table, and the area number in the illumination area 41, and a wireless terminal which is allocated thereto are stored by being associated with each other. Here, as an example, a state is illustrated in which the area 2 is allocated to the wireless terminal 35-2 with a terminal ID “bbbb”, and the area 3 is allocated to the wireless terminal 35-3 with a terminal ID “cccc”. In addition, a state is illustrated in which the area 1 and area 4 are not allocated to any of the wireless terminals.

In addition, the controller 31 writes a terminal ID “aaaa” of the wireless terminal 35-1 in a column of “allocation terminal ID” of the area 1 of the allocation table which is illustrated in FIG. 13, after confirming that the area 1 is not allocated to any of the wireless terminals (ACT 37). Further, the controller 31 makes the ON/OFF control by the switch 36a with respect to the lighting fixtures 33 of the area 1 invalid (ACT 38). That is, it becomes a state in which it is not possible to turn on, or off the lighting fixtures 33 even if the switch 36a is operated.

Thereafter, the controller 31 transmits lighting control permission information as information denoting that setting of the controller 31 is performed so that the ON/OFF control of the lighting fixtures 33 in the area 1 is exclusively performed from the wireless terminal 35-1 to the wireless terminal 35-1 (ACT 39). In addition, the controller 31 allocates the area 1 to a wireless terminal which transmits the received area instruction information first, when receiving the plurality of pieces of area instruction information with different terminal IDs. In this case, the controller 31 transmits information of not allowing lighting control to a wireless terminal to which the area 1 cannot be allocated.

The wireless terminal 35-1 which receives the lighting control permission information through the wireless communication device 32 can exclusively perform the ON/OFF control of the lighting fixtures 33 in the area 1 according to an operation by a user of the own device, hereinafter (ACT 40). In ACT 40, when performing the ON/OFF control of the lighting fixtures 33 in the area 1, the wireless terminal 35-1 transmits control information as information denoting ON or OFF (including terminal ID), for example, to the controller 31. On the other hand, the controller 31 which receives the control information through the wireless communication device 32 confirms whether or not the terminal ID which is included in the control information is stored by being associated with the area 1 by referring to the allocation table which is illustrated in FIG. 13. In addition, the controller 31 performs the ON/OFF control of the lighting fixtures 33 in the area 1 according to the instruction of the control information when the terminal ID included in the control information, and the area 1 are stored by being associated with each other.

Thereafter, when the exclusive control of the lighting fixtures 33 in the area 1 is cancelled, the wireless terminal 35-1 transmits the cancellation notice (including terminal ID) to the controller 31 according to a user operation (ACT 41).

The controller 31 which receives the cancellation notice through a wireless communication device 32 removes the terminal ID “aaaa” of the wireless terminal 35-1 which is described in the column of “allocation terminal ID” of the area 1 of the allocation table which is illustrated in FIG. 13 (ACT 42). In addition, the ON/OFF control by the switch 36a with respect to the lighting fixtures 33 in the area 1 is made valid (ACT 43). That is, the lighting fixture 33 is in a state of being turned ON/OFF by the operation of the switch 36a. Thereafter, the controller 31 transmits a cancellation completion notice which denotes completion of the cancellation to the wireless terminal 35-1 (ACT 44). Hereinafter, the ON/OFF control of the lighting fixtures 33 in the area 1 is performed by the operation of the switch 36a.

### Operation of Controller 31

Subsequently, operations of the controller 31 according to the embodiment will be specifically described. FIG. 14 is a flowchart which illustrates an example of the operations of the controller 31. According to the embodiment, a control with respect to the area 1 will be described. In addition, controls with respect to other areas are the same.

In the initial state, the controller 31 waits for an operation of the switch 36a with respect to the area 1 (ACT 51:NO, ACT 52:NO), and when there is an operation of the switch 36a (ACT 52:YES), performs the ON/OFF control of the lighting fixtures 33 in the area 1 (ACT 53), and waits for the operation of the switch 36a with respect to the area 1 again (ACT 51:NO, ACT 52:NO). In addition, the controller 31 repeatedly executes the processes in Acts ACT 51 to ACT 53 until the control of the lighting fixtures 33 in the area 1 using the switch 36a is made invalid (ACT 51:YES) by receiving the area instruction information from a predetermined wireless terminal. Here, as an example, the following operations will be described by assuming that the wireless terminal 35-1 transmits the area instruction information.

When the control with respect to the lighting fixtures 33 in the area 1 using the switch 36a is made invalid (ACT 51:YES), the controller 31 waits for the ON/OFF control from the wireless terminal 35-1 (ACT 54:NO, ACT 55:NO). In addition, when there is the ON/OFF control from the wireless terminal 35-1 (ACT 54:YES), the controller waits for the ON/OFF control from the wireless terminal 35-1 again (ACT 54:NO, ACT 55:NO) after performing ON/OFF control of the lighting fixtures 33 in the area 1 (ACT 56). Thereafter, the controller 31 repeatedly performs processing of waiting for the ON/OFF control from the wireless terminal 35-1 (ACT 54:NO, ACT 55:NO), and the ON/OFF control of the lighting fixtures 33 in the area 1 (ACT 56) until receiving the cancellation notice from the wireless terminal 35-1. In addition, when receiving the cancellation notice from the wireless terminal 35-1 (ACT 55:YES), the controller 31 makes the control with respect to the lighting fixtures 33 in the area 1 using the switch 36a valid, and proceeds to processing of waiting for the operation of the switch 36a with respect to the area 1 (ACT 51:NO, ACT 52:NO).

### Effect of Fourth Embodiment

As described above, in the lighting control system according to the embodiment, for example, when the wireless terminal 35-1 transmits an area instruction information denoting that the lighting fixtures 33 in the area 1 is desired to be exclusively controlled, and the control with respect to the lighting fixtures 33 in the area 1 is permitted as a response thereof, the control of the lighting fixtures 33 in the area 1 is performed. In addition, the controller 31 determines whether or not the area 1 which is denoted by the area instruction information is allocated, and when not being allocated, the switch control with respect to the lighting fixtures 33 in the area 1 is made invalid, and the control of the lighting fixtures 33 in the area 1 is permitted from the wireless terminal 35-1. In this manner, lighting in a predetermined area in the illumination area which is shared by a plurality of users can be exclusively ON/OFF controlled by a specified individual.

In addition, according to the embodiment, when the controller 31 receives a plurality of pieces of area instruction information of which terminal IDs are different, a desired area is allocated to a wireless terminal which transmits the received area instruction information first, but, it is not limited to this. For example, when the controller 31 stores the terminal ID of the wireless terminal to which the above described application software is installed, and a priority order of the wireless terminal having the terminal ID by associating both with each other in advance, and receives the plurality of pieces of area instruction information of which the terminal IDs are different, the desired area may be allocated to a wireless terminal with the highest priority order.

In addition, according to the embodiment, in the processing in ACT 35, it is assumed that, even when the area (portion which is surrounded with dotted line) which is already allocated to another wireless terminal is touched, there is no processing to be performed, but, it is not limited to this. For example, when the priority order is set as described above, the wireless terminal 35-1 may also generate an area instruction information (including terminal ID) denoting that the lighting fixtures 33 in the area 2 is desired to be exclusively controlled, when a user of the wireless terminal 35-1 touches a portion of the area 2 which is surrounded with the dotted line, and transmit the information to the controller 31. In this manner, the controller 31 can allocate the area 2 to a wireless terminal of which the priority order is high (wireless terminal 35-1, or wireless terminal 35-2) by performing a determination based on the priority order. That is, when the wireless terminal 35-2 has a high priority order, the allocation table in FIG. 13 is maintained without being updated, and when the wireless terminal 35-1 has a high priority order, the column of allocation terminal ID of the allocation table in FIG. 13 is updated to the terminal ID of the wireless terminal 35-1 “aaaa” from the present “bbbb”.

In addition, according to the fourth embodiment, the layout chart of the illumination area is created based on the area information of the illumination area from the control unit on the screen of a display of the wireless terminal which is the information terminal device, and displays the layout chart on the screen of the display, but, even in the first to third embodiments, the area instruction information may be generated such that the lighting control device 5 as the control unit transmits the layout chart of the illumination area to the smart phone 11 according to an acquisition request of the area information of the illumination area from the smart phone 11 as the information terminal device, the smart phone 11 displays the layout chart on the screen of the display, and the area instruction information is generated based on the division area which is instructed using the layout chart.

In addition, all, or a part of the programs which executes the above described operations is recorded, or stored in a portable medium such as a flexible disk, a CD-ROM or the like, and a storage medium such as a hard disk, as a computer program product. The program is read out by a computer, and all or a part of the operations is executed. Alternatively, all, or a part of the programs can be distributed, or provided through a communication network. A user can easily realize the lighting control system, and the lighting control method according to the embodiments by downloading the program through the communication network, and installing the program to the computer, or by installing the program to the computer from a recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting control system comprising:
at least one first lighting fixture; and
an information terminal device which can execute an application program which controls the first lighting fixture, and includes an execution control unit which executes the application program when detecting first information relating to a second lighting fixture.

2. The system according to claim 1,
wherein the information terminal device includes a first command transmission unit which transmits a first command signal with respect to the first lighting fixture by executing the executed application program.

3. The system according to claim 1,
wherein the information terminal device includes a second command transmission unit which transmits a second command signal with respect to the first lighting fixture by executing the started application program when detecting second information relating to the second lighting fixture, and an ending control unit which ends the application program after transmitting the second command signal.

4. The system according to claim 1,
wherein the first information is information denoting an ON state of the second lighting fixture.

5. The system according to claim 4,
wherein the ON state is determined based on illuminance of illumination light of the second lighting fixture which is detected in the information terminal device, a connection state of the information terminal device and the second lighting fixture, or presence or absence of reception of a predetermined first signal from the second lighting fixture in the information terminal device.

6. The system according to claim 3,
wherein the second information is information denoting an OFF state of the second lighting fixture.

7. The system according to claim 6,
wherein the OFF state is determined based on the illuminance of illumination light of the second lighting fixture which is detected in the information terminal device, the connection state of the information terminal device and the second lighting fixture, or presence or absence of reception of a predetermined second signal from the second lighting fixture in the information terminal device.

8. A lighting control method comprising:
detecting first information relating to a first lighting fixture in an information terminal device; and
executing an application program which controls a second lighting fixture in the information terminal device when detecting the first information.

9. The method according to claim 8, further comprising:
detecting second information relating to the first lighting fixture in the information terminal device;
transmitting the second command signal with regard to the second lighting fixture from the information terminal device by executing the application program when the second information is detected; and
ending the application program after transmitting the second command signal.

10. A non-transitory computer readable storage medium in which a program relating to a method of controlling a first lighting fixture is stored,
wherein the program is a program which causes a central processing unit of an information terminal device to execute a function of executing an application program which controls the first lighting fixture when a first information relating to a second lighting fixture is detected.

11. The storage medium according to claim 10,
wherein the program causes the central processing unit of the information terminal device to further execute:
a function of transmitting a second command signal with respect to the first lighting fixture from the information terminal device by executing the application program when second information relating to the second lighting fixture is detected; and
a function of ending the application program after transmitting the second command signal.

12. A lighting control system comprising:
at least one first lighting fixture;
at least one second lighting fixture; and
information terminal device which can execute an application program which controls the first lighting fixture, and includes an execution control unit which executes the application program when detecting first information relating to the second lighting fixture.

13. The system according to claim 12,
wherein the information terminal device includes a second command transmission unit which transmits a second command signal with respect to the first lighting fixture by executing the started application program when detecting second information relating to the second lighting fixture, and an ending control unit which ends the application program after transmitting the second command signal.

14. The system according to claim 12, further comprising:
a control unit which controls the at least one first lighting fixture,
wherein the control unit sends area information of an illumination area as a reply when receiving an acquisition request of area information of the illumination area from the information terminal device, and
wherein the information terminal device creates a layout chart of the illumination area based on a received area information, and displays the chart, and creates area instruction information based on a division area which is instructed using the layout chart.
